(19) United States
(12) Patent Application Publication
(10) Pub. No.: US 2014/0129177 A1
(43) Pub. Date: May 8, 2014

(54) Systems and Methods for Frequency-Based Stride Length Correction in a Pedometer Device

(71) Applicant: MOTOROLA MOBILITY LLC, Libertyville, IL (US)

(72) Inventors: Julius S. Gyorfi, Vernon Hills, IL (US); Amitkumar N. Balar, Mundelein, IL (US); Shakil Barkat, San Jose, CA (US); Sajid I. Dalvi, Aurora, IL (US); Tushar Janefalkar, San Jose, CA (US); Andrew M. Slonneger, Crystal Lake, IL (US)

(73) Assignee: Motorola Mobility LLC, Libertyville, IL (US)

(21) Appl. No.: 13/671,245

(22) Filed: Nov. 7, 2012

(51) Int. Cl. G01C 22/00; G06F 19/00

(52) U.S. Cl. CPC G01C 22/006; G06F 19/00
USPC 702/160

(57) ABSTRACT

A pedometer or other stride-detection device (304) can record the number of strides, and the frequencies of those strides, during a running or other session using a detector (306). The device (304) can report an estimated total elapsed distance (318) at the end of the session, based on the number and estimated lengths of each stride. The reported distance can be calculated using estimates for stride lengths at various frequencies based on a user profile (210), as well as a correction value table (308) and a frequency count table (202). At the end of each session, a corrected distance can be received by user input based on a treadmill display, or other means. A frequency-based correction factor can be updated based on an error ratio of the corrected and reported distances, which can be limited by a correction factor limit and distributed based on a stride frequency probability distribution.

### FIELD

The present teachings relate to systems and methods for frequency-based stride length correction in a pedometer device using post-session calibration, and more particularly, to platforms and techniques to generate values for distance traveled when using a pedometer device.

### BACKGROUND

In personal sports, health, and other applications, a variety of pedometer devices have been marketed which record the number and/or frequency of stride steps being taken by the user. That data is then converted into an estimated value for the distance that has been traveled by the user in a given walking, running, or other session.

In known pedometer platforms, the stride frequency data is supplied by an integral stride detector and used as input to a set of distance calculations. Those calculations assume or estimate the distance of each stride taken by the user, after strides are detected. An overall average stride length based on human biomechanical models and/or empirical averages can be used for those calculations. The degree of deviation in actual stride length from user to user can, however, be significant, and the use of “one size fits all” stride length models can result in total distance results whose accuracy can be less than satisfactory for a wide range of users.

In some cases, commercial pedometer products have attempted to incorporate refinements to stride length models to enhance the accuracy of total distance readings. Some pedometer products have, for instance, provided users an ability to enter their gender, height, weight, age, and/or other physical characteristics and used lookup tables to match the user's physical profile with empirical data or models tailored to those demographic categories. In cases, the estimated distance may be multiplied by some type of correction or scaling factor to produce an adjusted distance output which more closely approximates the actual distance traveled by the user, given his or her particular physical traits.

Although some pedometer products work well for some users, pedometer and other measurement devices would benefit from more accurate distance estimates for wider classes of users.

### DESCRIPTION OF DRAWINGS

The accompanying drawings, which are incorporated in and constitute a part of this specification, illustrate implementations of the present teachings and, together with the description, serve to explain the principles of the present teachings. In the figures:

FIG. 1 illustrates two stride frequency-based tables; one in which a stride frequency distribution can be encoded in a frequency count table and one in which stride length correction factors can be encoded in a correction value table; where both tables can be used in systems and methods for frequency-based stride length correction in a pedometer device using post-session calibration, according to various implementations;

FIG. 2 illustrates a pedometer platform or device operating during a running or other session, according to various implementations;

FIG. 3 illustrates a pedometer platform or device operating using post-session calibration, according to various implementations; and

FIG. 4 illustrates a flowchart of processing that can be used in frequency-based stride length correction in a pedometer device using post-session calibration, including deriving frequency-based correction factors or values, according to various implementations.

### DETAILED DESCRIPTION

Implementations of the present teachings relate to systems and methods for frequency-based stride length correction in a pedometer device with optional post-session calibration. More particularly, implementations relate to platforms and techniques for generating estimated distance readings from pedometer and other devices which incorporate corrected or adjusted stride length values using frequency-based correction factors. The distance contributions from strides made at different frequencies are corrected or adjusted in proportion to their statistical distribution to traveled distance in a given user's history. The corrected value for a given user can accordingly achieve a higher degree of accuracy when compared against derivations that fail to take stride frequency distributions into account.

In a given session, it will typically be true that users spend different amounts of time walking or running at different stride frequencies, and the strides made at those frequencies may be of different lengths. Thus the contributions to total distance made by the strides taken at each stride frequency will be different as well. For instance, many users may exhibit a stride pattern where initial strides during a session will occur with lower frequency and entail a shorter stride length, followed by a gradual buildup to higher-frequency strides that cover a greater stride length. Various implementations of the disclosed systems and methods seek to adjust for these frequency-based differences in stride length to develop a more accurate distance calculation for a user's pedometer.

Reference will now be made in detail to exemplary implementations of the present teachings, which are illustrated in the accompanying drawings. Where possible the same reference numbers will be used throughout the drawings to refer to the same or like parts.

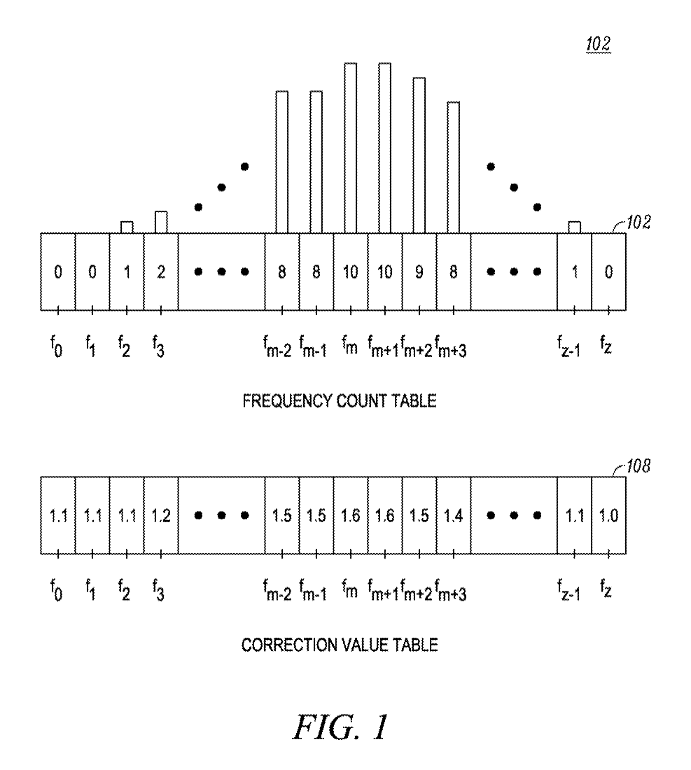

FIG. 1 illustrates a frequency count table 102 that can be used in systems and methods for frequency-based stride length correction in a pedometer device. As shown, the frequency count table 102 can encode or reflect a histogram or other distribution of stride frequencies recorded for a user of a pedometer and/or other device designed to record the distance traveled by a user operating that device while walking, running, or performing other activities.

As shown, for each stride frequency captured for the user, a pedometer can store a count of the number of strides recorded at that frequency. The frequency count table 102 can record that data on a cumulative basis, recording and updating the individual counts for the various frequencies after successive walking, running, or other sessions. The frequency count table 102 can be built into a user profile or history for a specific user and, in general, the frequency count table 102 will reflect a probability distribution of the stride frequencies registered for the user during the user's walking, running, or other activities.

For a number of users, the probability distribution encoded in the frequency count table 102 will reflect a distribution where there are relatively few stride events recorded at some stride frequencies (e.g., at frequency extremes such as very slow walking and very fast running) and a significant number of stride events recorded at a characteristic stride frequency or group of stride frequencies (e.g., at a natural walking stride frequency and a target jogging stride frequency).

FIG. 1 also illustrates a correction value table 108 that can be used in systems and methods for frequency-based stride length correction in a pedometer device using post-session calibration. As shown, the correction value table 108 is of the same size as the frequency count table and can store a stride-length correction factor for each stride frequency. The correction factor is a value that is used to adjust the estimated stride length corresponding to each particular stride frequency. Thus, as shown in table 108, strides taken at certain stride frequencies (e.g., fₘ₋₂, fₘ₋₁, fₘ₊₂) will have a 1.5 correction factor applied, which means that the pedometer will report a 50% longer stride length (compared to the pedometer's stride length model) for each stride taken at those three frequencies. This seems to indicate that this hypothetical user takes long strides compared to the pedometer's stride length model (perhaps due to running style, physical height, and/or calibration error).

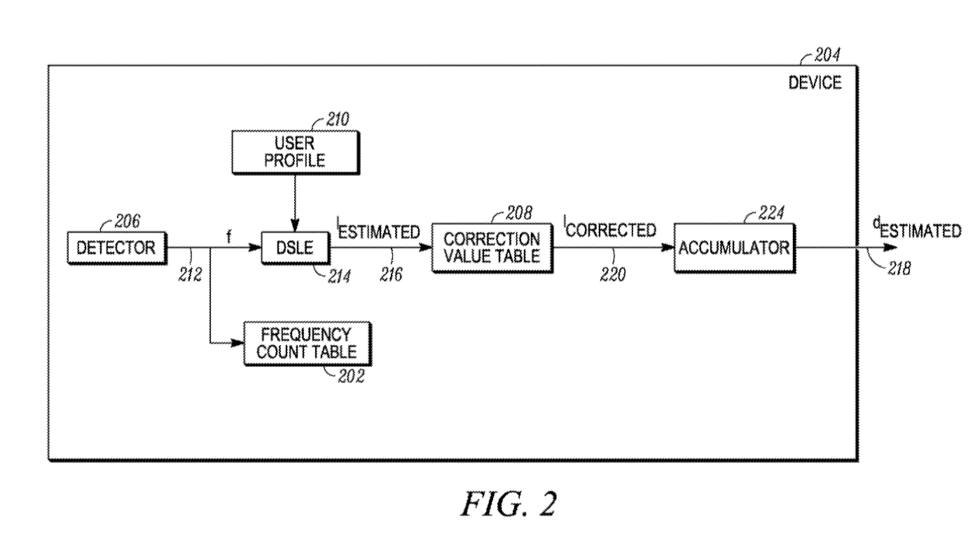

FIG. 2 illustrates a device 204 in which systems and methods for frequency-based stride length correction in a pedometer device can operate. In implementations, the device 204 can be or include a pedometer device or system, such as a pedometer which can be held or worn by a user such as, for example, on their clothing, foot, leg, hip, arm, or wrist. The device 204 can incorporate a detector 206 capable of detecting the impact of the user's stride on the ground, on a treadmill, or other surface. In implementations, the detector 206 can be or include a pendulum or gear-type element, an accelerometer, a gyroscope, and/or other detector hardware, sensor, or module. The device 204 can include a clock (not shown), to permit the device 204 to capture a set of current stride frequency measurements 212 reflecting the number of strides per second taken by the user while walking, running, or performing other activities. That data can be captured and stored in a frequency count table 202 within a memory component of the device 204.

The device 204 can be configured to conduct various operations, both during a current activity session and after that session is concluded. According to aspects, the device 204 can operate in two phases, one during a running or other workout or session, and another after the session is complete and a measured or “corrected” distance can be entered based on sources or measurements other than the pedometer itself.

In implementations as shown in FIG. 2, the device 204 can likewise incorporate a dynamic stride length estimator 214, configured to perform operations related to distance calculations, as described herein. The dynamic stride length estimator 214 can be or include a processor, software, logic, service, and/or other resources to perform distance-related operations as described herein. In implementations, while a walking, running, or other workout is being conducted, the dynamic stride length estimator 214 can operate to receive stride frequency measurements 212 from the detector 206. The stride frequency measurements 212 can include a series of measurements generated by recording the elapsed time between strides detected by the detector 206. The dynamic stride length estimator 214 can also communicate with a user profile 210.

The user profile 210 can be or include a local data store recording information related to the user, such as the user's gender, age, height, weight, estimated stride length, and/or other physical or other characteristics of the user. For instance, for first-run purposes or at other times, the user profile 210 can include an estimated, calibrated, and/or default stride length to apply to each stride taken by the user at a given frequency, before other data is gathered about the user's particular stride or activity behavior.

The user profile 210 can indicate for instance, that for a current walking, running, or other session by a female user, a stride length of 0.75 meter will be assigned or recorded for each detected stride at all stride frequencies. This would be a very simple stride-length model perhaps based on a crude estimate of a statistically “average” woman's stride length while walking. Other, more complicated stride length values, including a distribution of different stride lengths according to stride frequency, can be encoded in the user profile 210. These differing stride length values may be developed using empirical data or a physiological model. When the stride frequency measurements 212 during a session are received, the dynamic stride length estimator 214 can retrieve or calculate the stride lengths for each stride event detected at a particular stride frequency from the user profile 210 and produce a set of estimated stride lengths 216 (shown as I_{estimated}).

The dynamic stride length estimator 214 can then transmit or enter the set of estimated stride lengths 216 to a correction value table 208, which can include a row of entries indexed by stride frequencies of the user. See FIG. 1 table 108. The stride frequencies used to index the correction value table 208 can span a predetermined range, such as 0 strides per second to 4 strides per second, or other ranges or values. The correction value table 208 can include entries for each stride frequency indicating a correction value to be applied to the estimated stride length assigned to each stride frequency.

Thus, for instance, for the first stride frequency value, the correction may be a factor of 1.1, while for the fourth stride frequency value, the correction may be a factor of 1.5. The estimated stride lengths 216 at each stride frequency can then be multiplied by the corresponding correction factors (1.1., 1.2, etc.) to derive an adjusted or corrected stride length 220 at each frequency (shown as I_{corrected}). Each corrected stride length 220 can then be passed into an accumulator 224 where it is added to an accumulated total traveled distance which can be displayed to the user of the device 204 on a display (not shown). The output of the accumulator is the reported distance 218 (shown as d_{estimated}) which represents an estimated distance which the user has traveled in a given session, based on the total number of strides taken so far, a given stride length per stride at a particular frequency, and frequency-based correction factors reflected in the correction value table 208 for the user. The value for the reported distance 218 can be calculated according to the following equation.

$${d}_{estimated} = {\sum }_{k = 1}^{n} DSLE ( {f}_{k} ) \cdot c ( {f}_{k} ) \qquad Equation 1$$

where k is an index ranging from 1 to n, n is the number of measurements taken during the user's activity, fₖ is the stride frequency measured during the k^{th} measurement, DSLE(fₖ) is the estimated stride length corresponding to stride frequency fₖ, and c(fₖ) is the correction factor for stride frequency fₖ.

It may be noted that for the first use of the device 204 for a particular user, the values of the correction factor for each stride frequency contained in the correction value table 208 can be set to a default value of 1. In this phase of operation, the device 204 will display or report the estimated distance 218 to be that distance directly predicted by the initial model of the user profile 210. Subsequent sessions will begin to build successively refined or adjusted values in the correction value table 208. The reported distance 218 in the first and subsequent sessions may or may not, however, always reflect an accurate total distance value for the user, prior to the processing and adjustments described herein.

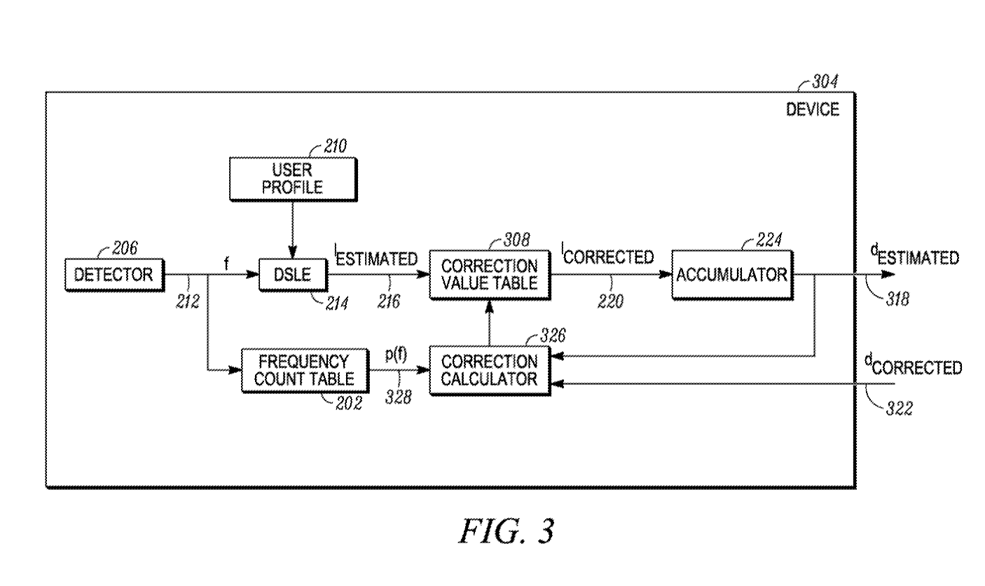

More specifically and as for instance illustrated in FIG. 3, after a session is completed, corrected, or updated, values for the actual distance traveled by the user can be incorporated in corrective processing applied by the device 304. In implementations as shown in FIG. 3, the device 304 can carry out distance processing in the same way as described above in connection with FIG. 2 using a set of stride frequency measurements 212 supplied to the dynamic stride length estimator 214, resulting in the outputting of a reported distance 318 (again, shown as d_{estimated}).

In implementations or operations as shown in FIG. 3, however, after a running or other session is completed, a corrected distance 322 can be received by or entered into the device 304, to be used to derive correction factors to further increase estimated distance accuracy. The corrected distance 322 can be or include a set of data manually entered by the user, such as the total elapsed distance reading taken from a known track distance, a treadmill machine, or another piece of exercise equipment which incorporates a distance tracking function. The corrected distance 322 can also or instead be captured or received from other sources, such as global positioning system (GPS) data received by radio frequency circuits located in the device 304 or an external device. The corrected distance 322 can likewise also or instead be received from a networked source external to the device 304, such as from a measurement device or service accessible by WiFi™, Bluetooth™, cellular, and/or other connection. In such cases, the device 304 can be configured with integral or other network capability.

In operations shown in FIG. 3, the corrected distance 322 can be transmitted to a correction calculator 326, along with the reported distance 318. The correction calculator 326 can update the correction factors in the correction value table 308 according to the following equation.

$$c ( {f}_{i} ) = c ( {f}_{i} ) \cdot ( 1 + p ( {f}_{i} ) \cdot [ \frac{{d}_{corrected} - {d}_{estimated}}{4 {d}_{estimated}} ] ) \qquad Equation 2$$

where c(fᵢ) is the correction value for each fᵢ in the correction value table 208, 308, fᵢ is the i^{th} stride frequency in both the correction value table 308 and the frequency count table 202, d_{corrected} is the corrected distance 322, d_{estimated} is the reported distance 318, and p(fᵢ) 328 is the probability that frequency fᵢ will be measured during a user's activity. The multiplicative term (¼) represents an optional correction limit factor, to constrain or limit the amount by which a particular stride length may be corrected based on the corrected distance 322 produced in any single session. While a term of (¼) is shown for the correction limit factor, it will be appreciated that other values less than 1, such as (⅕), (⅓), or others, can be used. It will likewise be appreciated that the correction limit factor can itself be updated or adjusted at different times.

In the foregoing Equation 2, the p(fᵢ) term represents a probability distribution function which indicates the marginal probability distribution of stride frequencies for the last running or other session. According to implementations, p(fᵢ) can be calculated for every frequency fᵢ by dividing the count for frequency fᵢ in the frequency count table 202 by the total count over all frequencies in the frequency count table 202, i.e., normalizing the histogram embodied in frequency count table 202 to generate the marginal probability distribution.

It may be noted that in the correction factors entered in the correction value table 308, the weighting or scaling of those factors in proportion to the relative frequency of each stride frequency value incorporates the fact that the strides taken at different stride frequencies contribute different amounts to the total reported distance. The frequency-adjusted correction factors reflected in the correction value table 308 can therefore weight the most common stride frequencies by the greatest cumulative amount, resulting in a total distance calculation in the reported distance 318 having enhanced accuracy.

For example, in a simplified case, a user runs a mile in 2000 steps with 1500 steps at a first frequency and 500 steps at a second frequency. If the reported estimated distance is 1.25 miles, the corrected distance is 1.00 mile, and the correction limit factor is 0.25, then the correction values can be computed as follows.

Given:

p(f₁)=1500/2000=0.75

p(f₂)=500/2000=0.25

d_{estimated}=1.25 miles, and

d_{corrected}=1.00 mile.

The corrected distance is −20% percent of the estimated distance, i.e. the relative correction factor is:

$$\frac{{d}_{corrected} - {d}_{estimated}}{{d}_{estimated}} = - 0.20$$

Dividing this by 4 simply reduces the amount of the relative correction factor to −5%. Applying the probabilities of each frequency to the relative correction factor results in 75% of the −5% relative correction factor, or −3.75% [i.e., (0.75)(−0.05)=−0.0375], being applied to the previous correction value for frequency f₁ and the remaining 25% of the −5% relative correction factor, or −1.25% [i.e., (0.25)(−0.05)=−0.0125], being applied to the previous correction value for frequency f₂.

The last step of adding the 1 in Equation 2 converts the relative correction factor into an absolute correction factor that can be used in the correction value table as a multiplier for the estimated stride lengths. In this example, we assume that the previous correction value at all stride frequencies is 1. Then:

$$c ( {f}_{1} ) = 1 + p ( {f}_{1} ) \cdot [ \frac{{d}_{corrected} - {d}_{estimated}}{4 {d}_{estimated}} ] = 1 + 0.75 \cdot [ \frac{1.00 - 1.25}{4 ( 1.25 )} ] = 0.9625$$

$$c ( {f}_{2} ) = 1 + p ( {f}_{2} ) \cdot [ \frac{{d}_{corrected} - {d}_{estimated}}{4 {d}_{estimated}} ] = 1 + 0.25 \cdot [ \frac{1.00 - 1.25}{4 ( 1.25 )} ] = 0.9875$$

Thus, the previous correction factors c(f₁) and c(f₂) can be multiplied by 0.9625 and 0.9875 based on the feedback from the corrected distance 322.

To summarize, a relative correction factor of −20% was determined (equal to an 80% absolute correction factor), which was reduced to a −5% relative correction factor that was then divided between stride frequencies f₁ and f₂ such that 75% of the relative correction factor was applied to f₁ and 25% of the relative correction factor was applied to f₂. The last step converted the relative correction factors into absolute correction factors suitable for the correction value table. So instead of applying a flat 80% (1.0-0.2=0.8) absolute correction factor irrespective of stride frequency, a 96.25% (0.9625) correction factor update was applied to frequency f₁ and a 98.75% (0.9875) correction factor update was applied to frequency f₂. Over multiple sessions, as the reported distance 318 converges with the corrected distance 322, any update to a correction factor will tend to converge to a multiplier of 1, which means that the correction factor will settle on a particular value. Of course, in reality, the correction factor may continue to adjust by slight amounts due to differing stride patterns and environments.

It may be noted that the adjustment to the correction factors in the correction value table 308 may be repeated after any session where the distance traveled is known independently of the device 304, which can result in values that develop or converge to an accurate long-term typical value for a user. In implementations, the adjustment process shown in FIG. 3 can therefore be stopped after some relatively long-term training of the correction value table 308, for instance based on predetermined criteria for the marginal change after the most recent session or sessions.

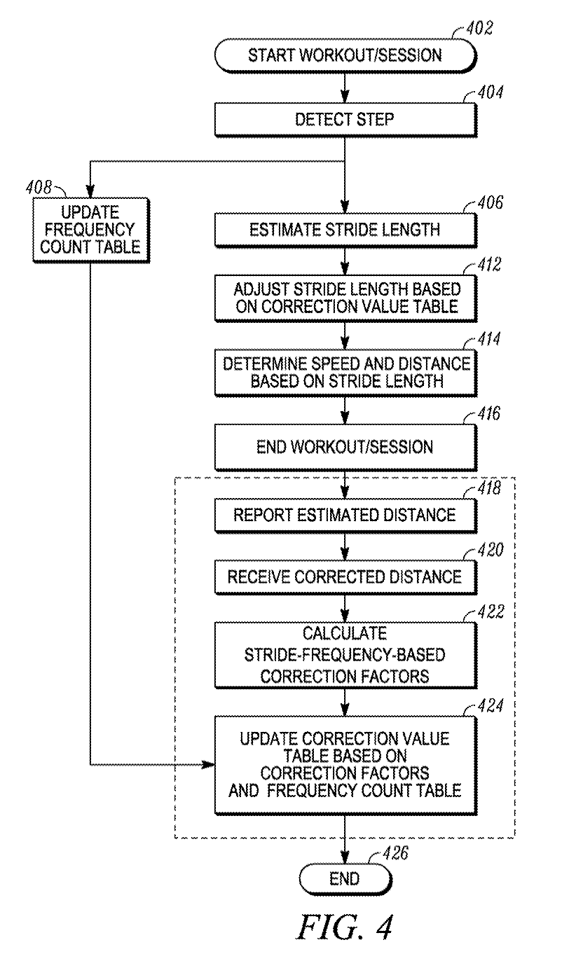

FIG. 4 illustrates a flowchart of stride frequency, stride length correction, and other processing that can be performed in systems and methods for frequency-based stride length correction in a pedometer device optionally using post-session calibration, according to various embodiments. In 402, a walking, running, or other session or activity, along with processing by the dynamic stride length estimator 214 and/or other logic, can begin.

In 404, the detector 206 can detect the occurrence of a step by the user, which can likewise be used to produce a stride frequency value. In 408, the stride frequency count table 202 is updated with the stride event at the detected stride frequency. In 406, the dynamic stride length estimator 214 can access the user profile 210 and/or a statistical model or engine to estimate the length of a stride based on the detected stride frequency. It may be noted that in implementations, the user profile 210 for more than one user can be stored in a device 204, 304. It may also be noted that in implementations, the user profile 210 can be stored in electronic or other storage in the device 204, 304, but can also or instead be accessed via networked data stores.

In 412, the stride length for the current detected stride can be adjusted based on the correction factor for the associated stride frequency in the correction value table 208, 308. In 414, the speed and distance traveled during the current session can be estimated in the accumulator 224 based on the corrected stride lengths and elapsed time since the beginning of the current session. In 416, the user can end their current workout or session.

In optional 418, the reported distance 218, 318 can be generated by the device 204, 304. In implementations, the reported distance 218, 318 can be displayed to the user. In 420, the corrected distance can be received into the device 304, for instance by the user entering the distance displayed on the display screen of a treadmill, or other type of exercise equipment. In 422, correction factors are calculated in correction calculator 326 according to Equation 2. In implementations, and as for example reflected in Equation 2, the correction value can be weighted or scaled by an adjustment limit factor, such as 0.25, 0.33, or other values, to constrain the amount by which adjustments are made for each session cycle.

In 424, the correction value table 308 can be updated based on the calculated correction factors and the marginal probability distribution derived from the frequency count table 202, thereby creating a set of correction values that are frequency-dependent based on the user's history and stride frequency probability distribution. In 426, processing can repeat, return to a prior processing point, jump to a further processing point, or end.

In implementations, the device 204, 304, and/or other hardware or platforms incorporating systems and methods described herein can comprise a platform including a processor communicating with memory, such as electronic random access memory, operating under control of or in conjunction with an operating system. The processor can be incorporated in one or more processor or multiprocessors, field programmable arrays, digital signal processors, and/or other computers, circuits, or hardware resources. The operating system when used can be, for example, a distribution of the Linux™ operating system, the Unix™ operating system, or other open-source or proprietary operating system or platform. The device can incorporate a data store, such as a database stored on a local hard drive or drive array, to access or store stride-related information, and/or subsets of selections thereof, along with other content, media, or other data. When equipped for networked communication, the device 204, 304, and/or other device can include a network interface, such as an Ethernet or wireless data connection, which in turn communicates with the one or more external networks, such as the Internet or other public or private networks. Other configurations of the device 204, device 304, associated network connections, and other hardware, software, and service resources are possible.

The foregoing description is illustrative, and variations in configuration and implementation may occur to persons skilled in the art. For example, while implementations have been described in which the device 204, 304 includes one dynamic stride length estimator 214, in implementations that estimator or similar or related logic can be implemented in multiple processors, software, or logic. Furthermore, the frequency count table 202 and the correction value table 208, 308 can be implemented as part of user profile 210 to enable multiple users of device 204, 304 to maintain separate sets of personalized tables. Other resources described as singular or integrated can in implementations be plural or distributed, and resources described as multiple or distributed can in implementations be combined. The scope of the present teachings is accordingly intended to be limited only by the following claims.

1. A method of calculating a distance traveled by a device, comprising:
receiving a stride event count and, for each stride event count, an associated stride frequency measurement;
generating a stride frequency distribution based on the stride event count and the stride frequency measurement;
accessing an estimated stride length for each stride frequency in the stride frequency distribution; and
generating a reported distance based on the stride event count, the stride frequency measurement, and the estimated stride length.

2. The method of claim 1, wherein accessing the estimated stride length comprises:
accessing an initial user stride length model based on physical user characteristics.

3. The method of claim 2, further comprising:
pre-calibrating the initial user stride length model.

4. The method of claim 1, further comprising:
updating the stride frequency distribution based on subsequent stride event counts and subsequent associated stride frequency measurements.

5. The method of claim 4, further comprising:
correcting a further subsequent reported distance based on the updated stride frequency distribution.

6. The method of claim 1, further comprising:
receiving a corrected distance traveled by the device;
generating a correction factor based on the corrected distance and the reported distance;
generating a frequency-based correction table based on the correction factor and the stride frequency distribution to correct the estimated stride length at each stride frequency; and
generating a subsequent reported distance using the frequency-based correction table.

7. The method of claim 6, further comprising:
updating the frequency-based correction table based on a corrected further subsequent reported distance.

8. The method of claim 6, wherein generating the correction factor comprises:
multiplying an error ratio between the corrected distance and the reported distance by an adjustment limit factor.

9. The method of claim 8, further comprising:
updating the adjustment limit factor.

10. The method of claim 6, wherein receiving the corrected distance comprises at least one of
receiving the corrected distance traveled entered by a user,
receiving the corrected distance traveled via a network connection, or
receiving the corrected distance traveled via a set of positioning signals.

11. The method of claim 6, wherein generating the subsequent reported distance comprises:
multiplying the estimated stride length for each stride frequency in the stride frequency distribution by an entry in the frequency-based correction table for the associated stride frequency to obtain a corrected stride length, and
accumulating the corrected stride length for all current stride event counts to generate the subsequent reported distance.

12. A device, comprising:
a detector configured to detect stride events and their associated stride frequencies;
a frequency count table, communicating with the detector, for generating a stride frequency distribution based on the stride events and their associated stride frequencies;
a stride length estimator, communicating with the detector, the stride length estimator being configured to
receive the stride events and their associated stride frequencies, and
access an estimated stride length for each stride event using the associated stride frequency; and
an accumulator for generating a reported distance based on a sum of the estimated stride lengths.

13. The device of claim 12, wherein the device further comprises:
memory for storing a user stride length model based on physical user characteristics.

14. The device of claim 12, wherein the frequency count table is further configured to update the stride frequency distribution based on subsequent stride frequency measurements.

15. The device of claim 12, wherein the device further comprises:
a frequency-based correction value table for correcting the estimated stride length at each stride frequency; and
a correction calculator configured to
receive a corrected distance traveled by the device,
generate a correction factor based on the corrected distance traveled and the reported distance, and
update the frequency-based correction value table based on the correction factor and the stride frequency distribution.

16. The device of claim 15, wherein the correction calculator is further configured to:
multiply an error ratio between the corrected distanced and the reported distance by an adjustment limit factor to generate the correction factor.

17. The device of claim 12, wherein the device further comprises at least one of
an input interface for receiving a corrected distance traveled entered by a user,
a network interface for receiving the corrected distance traveled via a network connection, or
a radio frequency interface for receiving the corrected distance traveled via a set of positioning signals.

18. The device of claim 12, wherein the detector comprises at least one of
a pendulum,
a gear,
an accelerometer, or
a gyroscope.
